(19) United States
(12) Patent Application Publication
(10) Pub. No.: US 2008/0115649 A1
(43) Pub. Date: May 22, 2008

(54) PROCESSES AND APPLIANCE FOR SLICING FOOD, SEPARATING AND STACKING SLICES AND PROTECTING ALL THEIR SURFACES FROM EXPOSURE TO THE ENVIRONMENT

(76) Inventor: Ovidio Carneiro Filho, Goias-GO (BR)

Correspondence Address: LUCAS & MERCANTI, LLP, 475 PARK AVENUE SOUTH, 15TH FLOOR, NEW YORK, NY, 10016, US

(21) Appl. No.: 11/560,589

(22) Filed: Nov. 16, 2006

(51) Int. Cl. B26D 1/54; B26D 7/06

(52) U.S. Cl. 83/762; 83/88

(57) ABSTRACT

This invention patent refers to processes and appliance for slicing food, stacking and protecting obtained slices from exposure to the environment, through a continued flexible separator, with foldable flaps, in contact with side, front and rear surfaces of referred slices. There available on the consumer market, at supermarkets and bakeries, manually sliced and stacked cheeses, susceptible to oxidation and contamination. Conditioning of these products in consumer's refrigerator does not provide protection for all contact surfaces of slices, which, often, dry up, become moldy and stick to each other.

The proposal of this invention is to protect all contact surfaces of food slices—even after their consumption has already started—when closing entrance doors to a possible contamination, especially for protein food with high moisture content, such as cheeses and sausages which are excellent means of microbial culture.

The main technical effect of this invention is the presence of foldable flaps, in the slice protection process. Through the flaps, formed by using a separator with shaft measurements larger than respective slice shaft measurements, that face protection is done corresponding to their thickness, places where the contamination and stacked food oxidation process starts.

This invention patent refers to processes and appliance with functions for slicing food, stacking and separating each slice and preventing them from getting in contact with the environment by using a continued flexible laminated between them, which, due to having larger shaft measurements than respective slice shat measurements forms flaps, which, due to being folded one on top of the other, especially protect side surface of stacked slices.

### PRIOR ART CONCEPT

Soft cheeses—mild hard type, mozzarella, provolone, cheddar, etc. and sausages, sold by industries to wholesale and retail markets, are manufactured in blocks, generally vacuum-packed and have an average 90 day validity period. When these products are sliced in supermarkets, bakeries, etc., before consumer's eyes or previously sliced and packed in trays, validity period becomes approximately five days. This is due to the absence of vacuum in the package and manual methods used for slicing, stacking and packing, since they do not allow for an effective protection, they expose food to the environment, enabling oxidation and contamination. It is not appropriate to place vacuum in packages with sliced natural food—not separated, mainly with soft cheeses and some sausages, because slices stick to each other, making separation difficult. When consumers pack in a refrigerator sliced food not separated and without protection, slices often become moldy and dry up; if they are not packed with outside protection—plastic film, for example, slices stick to each other.

The sliced product consumer, especially of cheeses and sausages, considering the short validity period and problems resulting from homemade packing of these products, is forced to go over to points of sale in short time intervals in order to be able to consume a natural sliced product, considered fresh. There are no at the disposal of the consumer market, sliced natural cheeses and sausages, hermetically sealed, which after their outside packages having been opened, unconsumed slices keep protected in all their surfaces.

The purpose of this patent application is to slice food blocks, stack, separate and protect all slice surfaces—especially side surfaces. This protection is done by the action of folded flaps of a continued flexible separator, which keep full protection for stacked slices—even after their consumption having been started—allowing consumer the chance of being able to consume sliced food, hermetically sealed during the manufacturing process, free of problems resulting from unsuitable handling, packaging and storage.

### DESCRIPTION OF FIGURES

FIG. 1—The appliance for alternatively slicing food blocks consists of a fixed frame (1A) in which a mobile frame slides (1B). One or more device groups can form part of the set performing the same functions;

FIG. 2—Spool shaft—is a shaft (e) supported on the top end of the device mobile frame, with the function to support flexible continuous laminated spools (b) and allow then to release, passively, segments of these laminated;

FIG. 3—Tractor set—is a device consisting of a shaft (e), a tractor cylinder (ct) and an opposing cylinder (co), fastened to the mobile frame, immediately below the spools, with the function of driving the flexible continuous laminated. At tractor cylinder ends corona rotate (c), geared to shields, upper (cs) and lower (ci), in ratchet-type bearings (rc)—which allow free movements in one of the rotation directions;

FIG. 4—Mobile base—it is a table, mobile frame base, which slides on the device fixed frame, mechanically driven (a). The table (4A) is hollow to allow passage to food blocks—through storing parts (a) and to give passage to flexible continuous separators (s)—through drivers (s);

FIG. 5—Storing part (a)—is a rounded or polygonal part, without lid and bottom, with measures and number of walls equal to the shape of blocks to be sliced, with functions of driving blocks (b) and giving them passage through the mobile table (m), from top to bottom to be sliced;

FIG. 6—Knife shield—is a device fastened to the bottom end of the storing part (a)—in corresponding plan to the movement end of food block cutting (b). The shield (acf) acts against the knife, with the function of preventing during the cutting process food slices from being displaced, as a result of the knife movement speed, to a position beyond the determined projection for forming slice stacks;

FIG. 7—Drivers—are devices located in sections in the mobile table (m), between storing parts (a) of food blocks (b), with the function of driving and giving passage to flexible separators (s) during the slice stacking and separating process;

FIG. 8—Cutting grid—is a device consisting of a grid, where hard support (a) and knife are fastened. Alternately the knife (fr) can be mobile, rotary (8A). It makes its movements in an immediate plan under the mobile table and is supported in tabs (g) fastened to the lower table surface. The grid has the function of supporting food blocks and cutting them for obtaining slices;

FIG. 9—Slice cutting process—the sequence of figures A, B, C and D demonstrates the slice cutting process (ft), where the support (a) and knife (f) make joint movements—at the same time as the support comes out of food block projection the knife, when starting cutting, goes on to perform the support function;

FIG. 10—Grid set—is used for slice food of a single block, it consists of the support grid (GA) which is supported on bearings that slide on cylindrical frames, by mechanical drive; through the cutting grid (GC), which consists of the knife (f), support (A) for the food block (BA) and storing part (a) and is supported on bearings that slide on cylindrical frames fastened to the support grid; and by the flexible separator grid (GS), which is a sliding frame, mechanically driven, consisting of the flexible separator spool (B), tractor cylinder (CT), opposing cylinder (CO) and driver (D). The flexible separator grid, in static position, stays off the support grid set movement plan;

FIG. 11—Grid set displacement—the grid set is displaced, by mechanical action, in order to place the support (A) in the slice cutting plan and placing;

FIG. 12—Cutting grid displacement (GC)—the cutting grid is displaced in the same displacement direction as the support grid, for cutting the slice and becoming the only support for the food block. The support (A) is displaced, concomitantly, off the slice cutting plan;

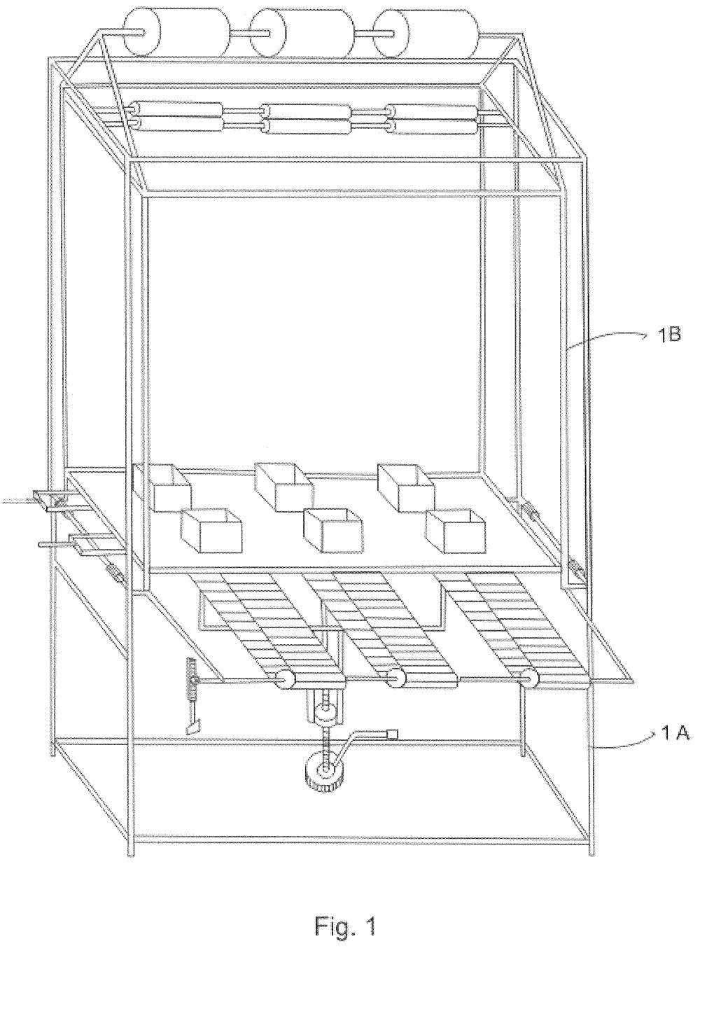

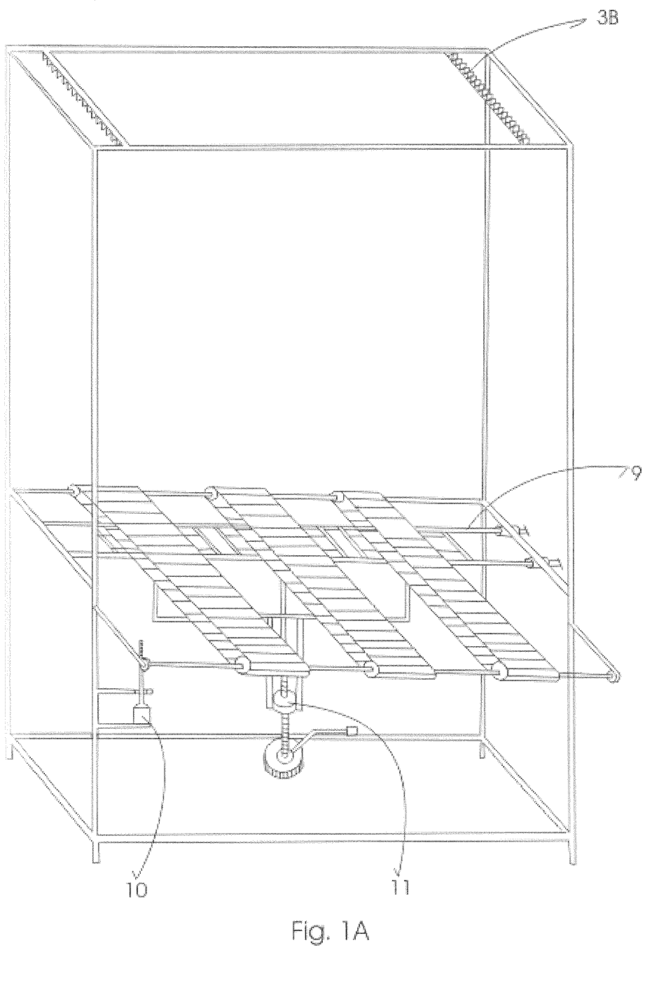

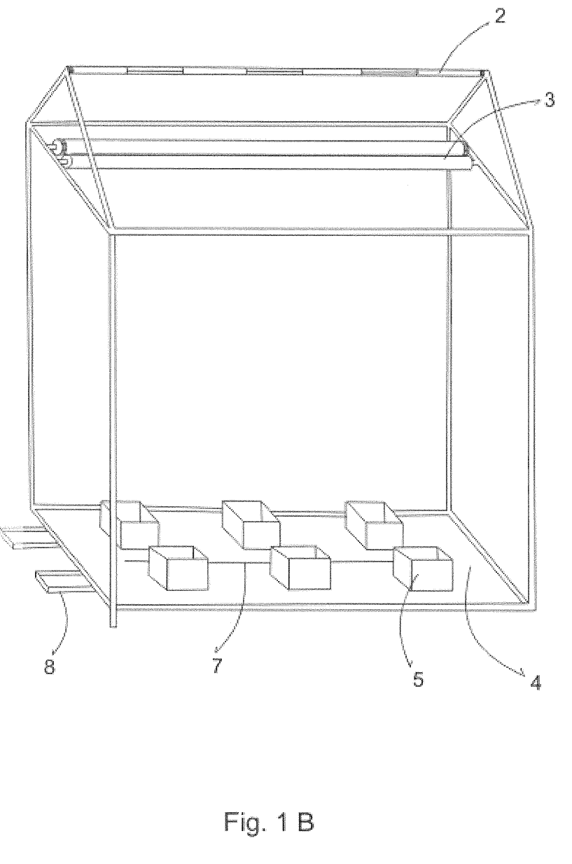

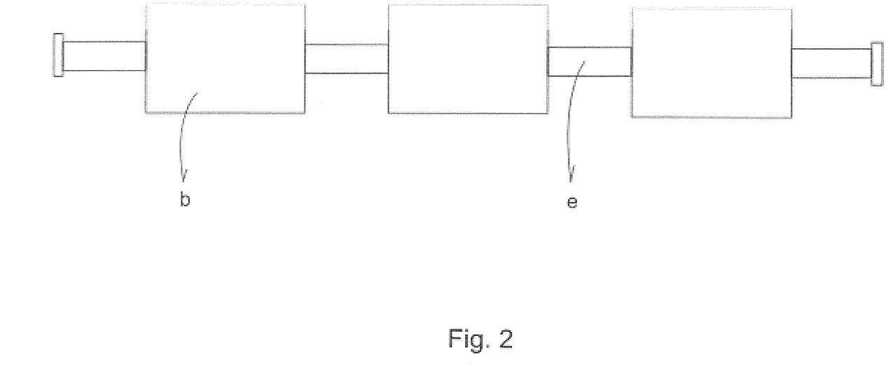

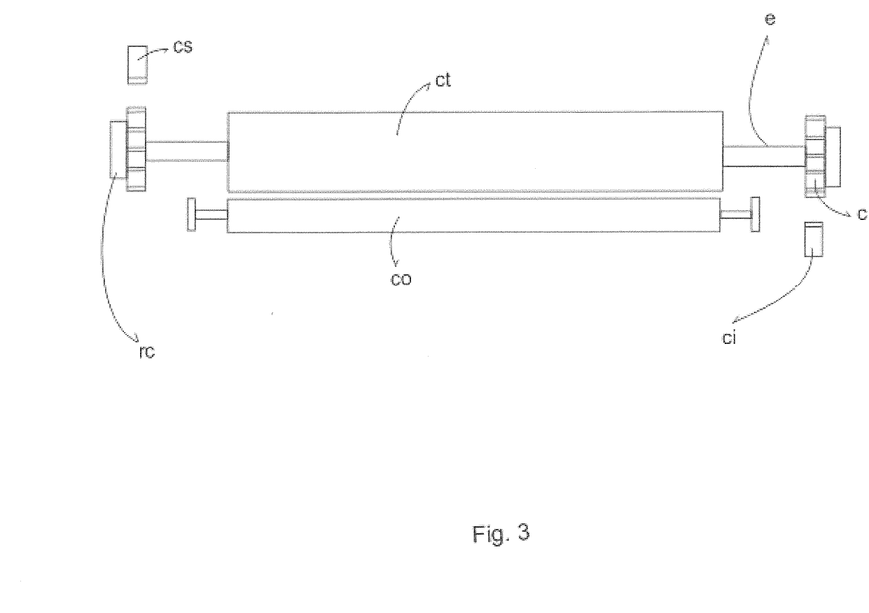

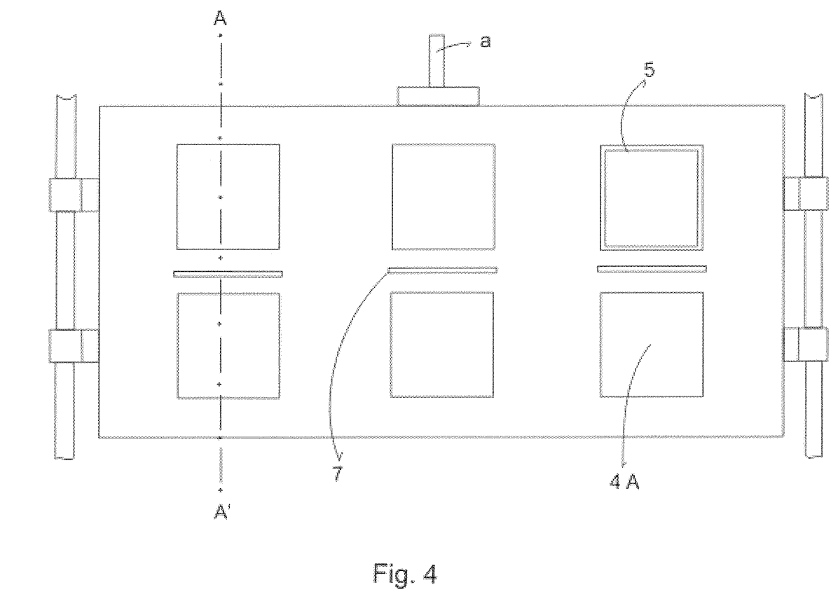

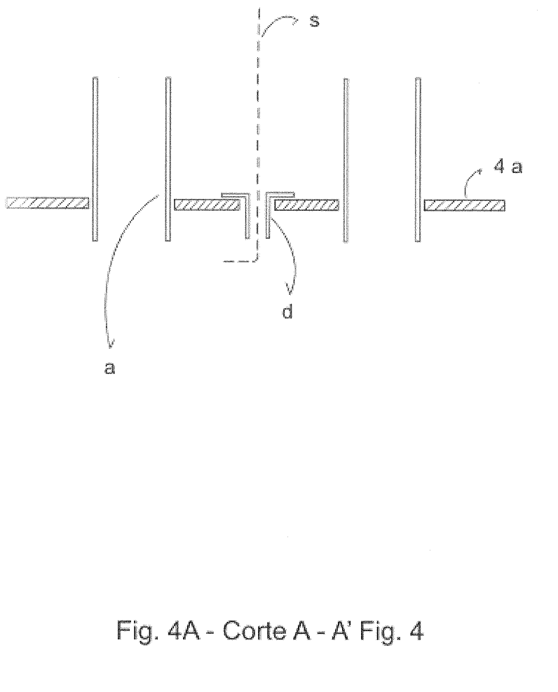

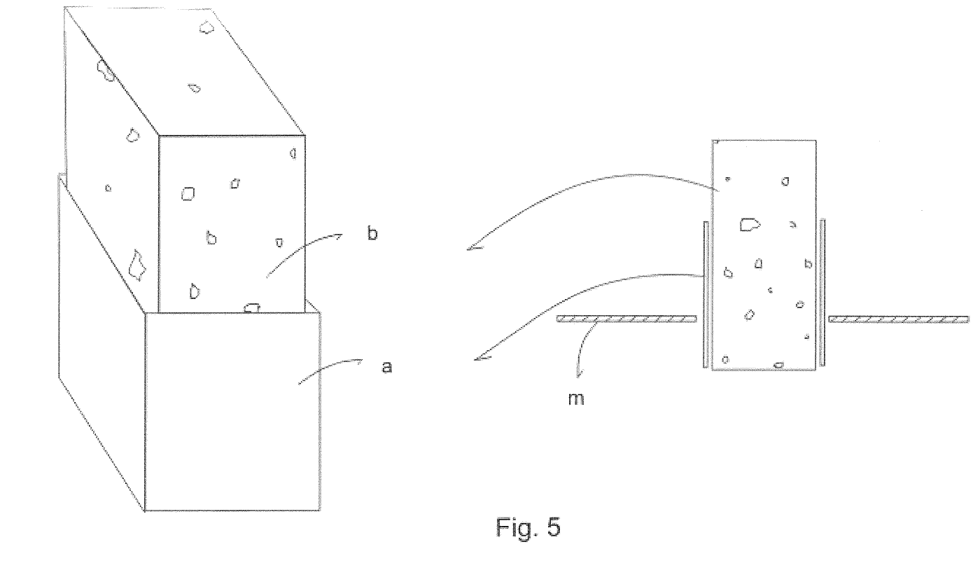

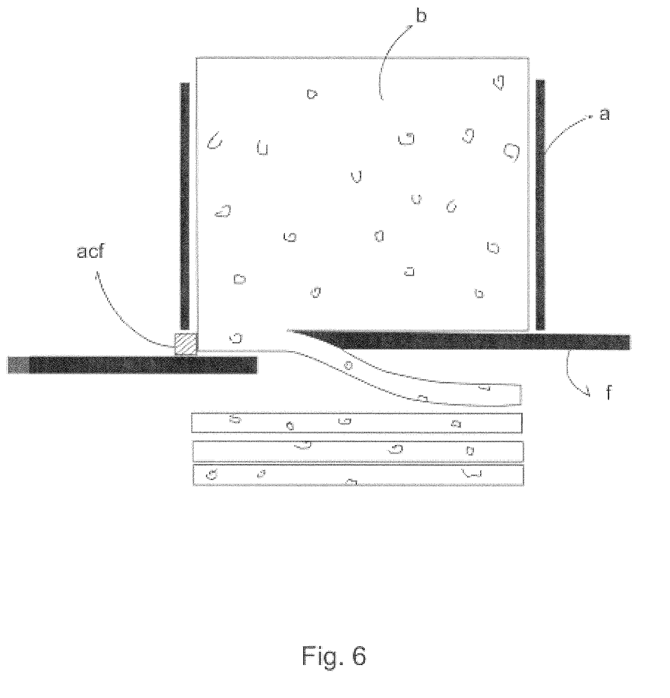

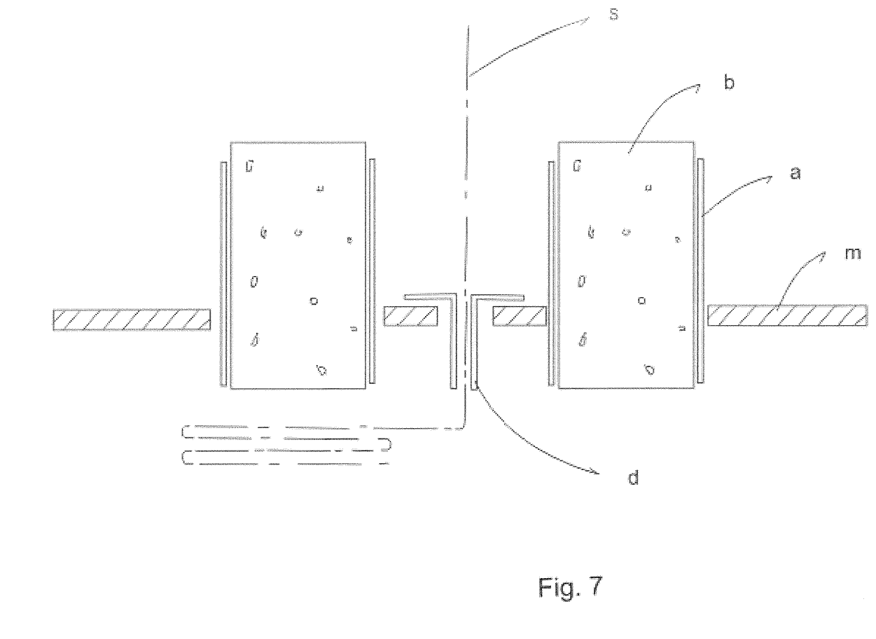

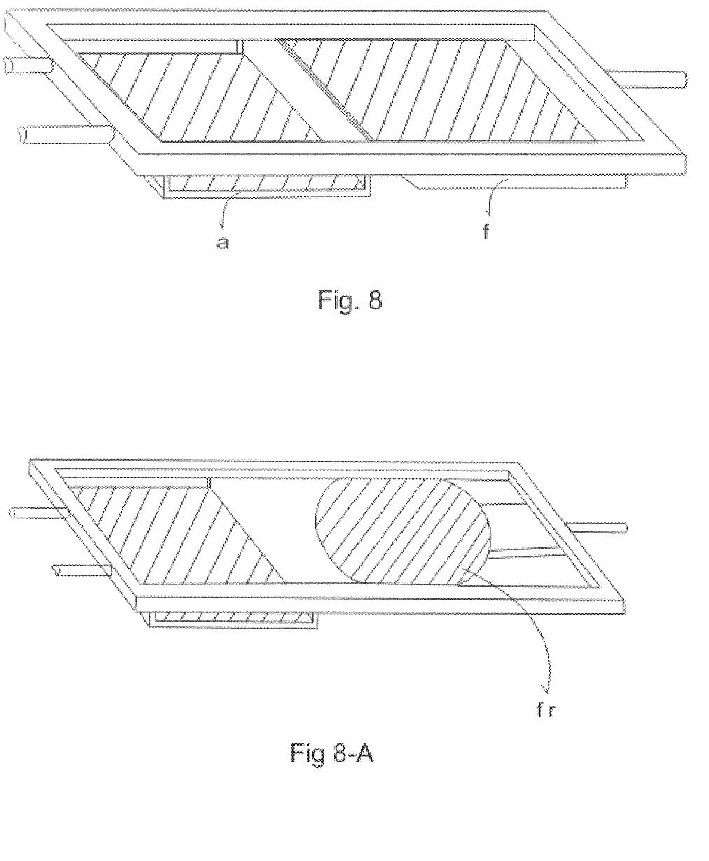

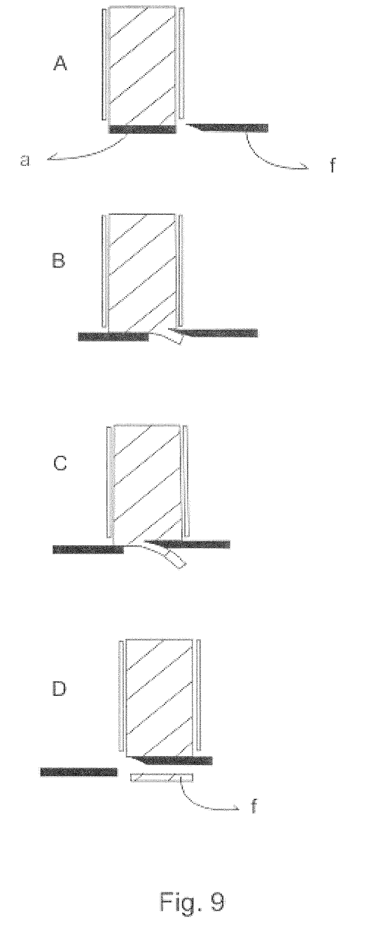

FIG. 1—Separator grid displacement—the separator grid (S) is mechanically displaced, in the perpendicular direction to support grid displacement (GA), in order to cover the slice (F) and exit the plan projection of a new slice placing;

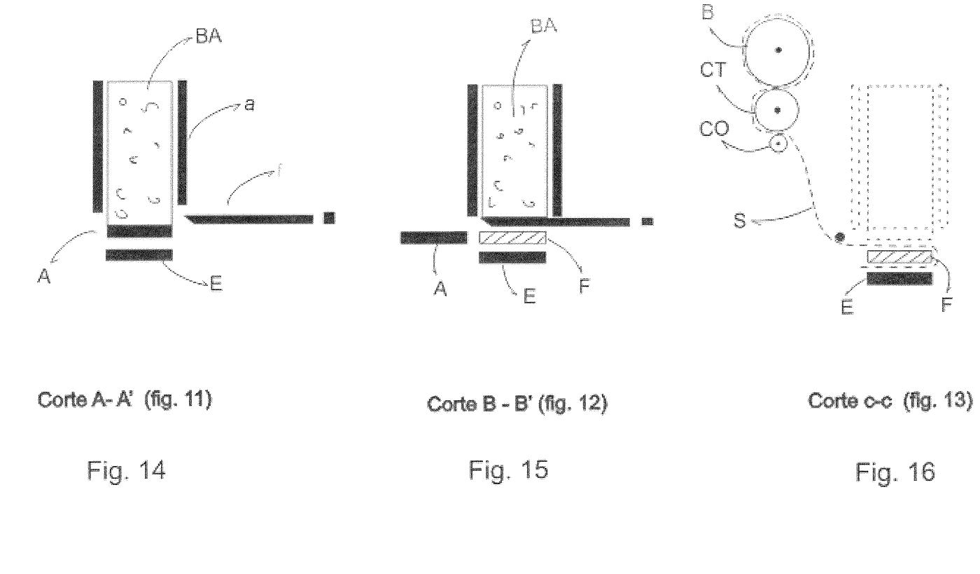

FIG. 14—Section A-A′—FIG. 11 section shows the cutting grid position (GC) in relation to the belt (E), support (A) and food block (BL), after support grid displacement (GA) and before cutting grid displacement;

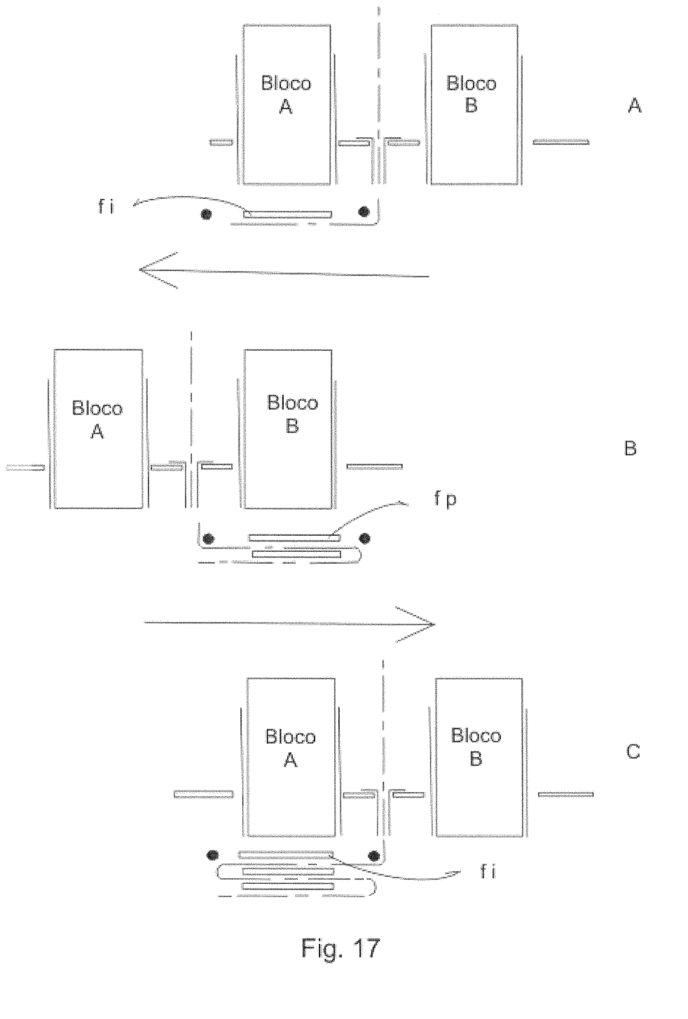

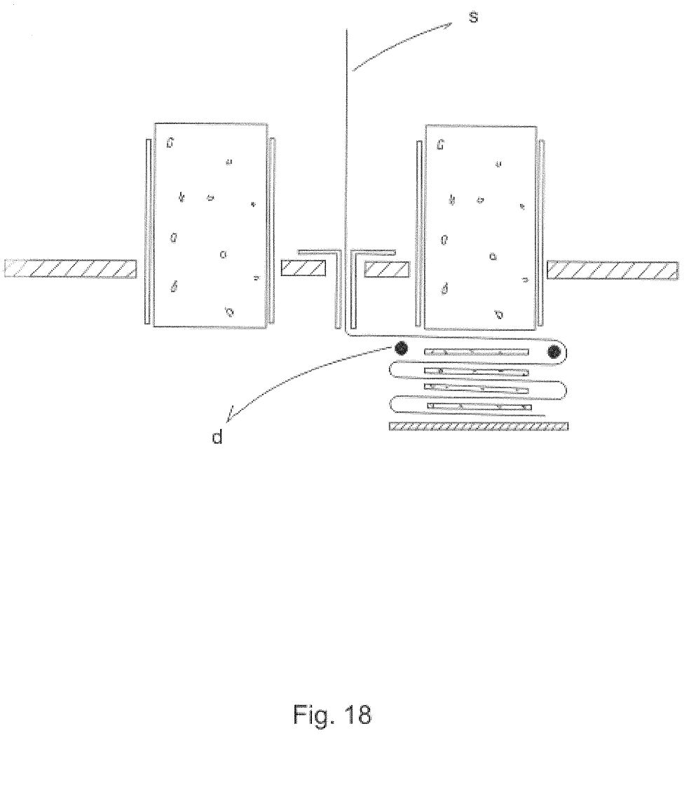

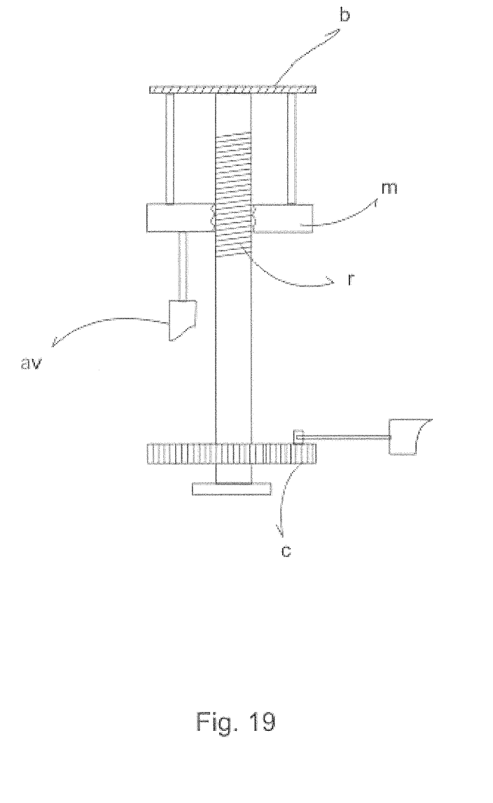

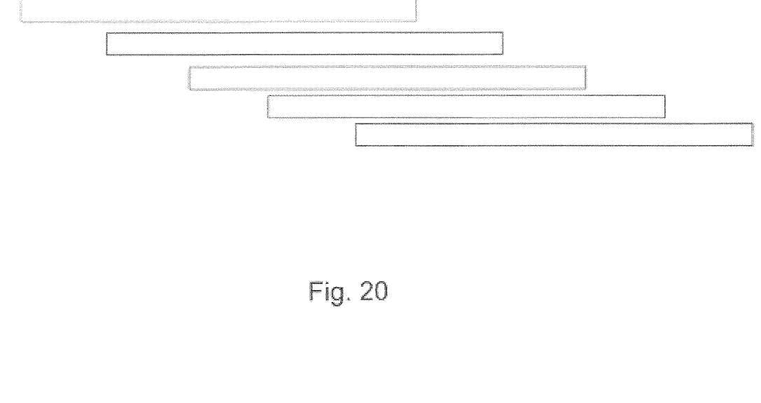

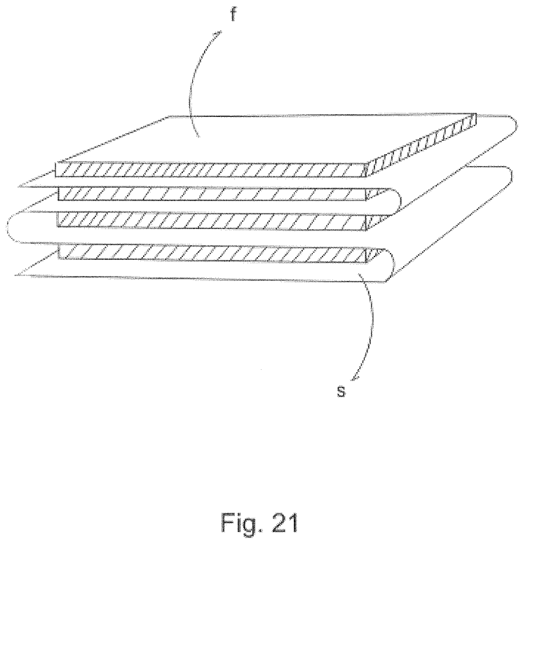

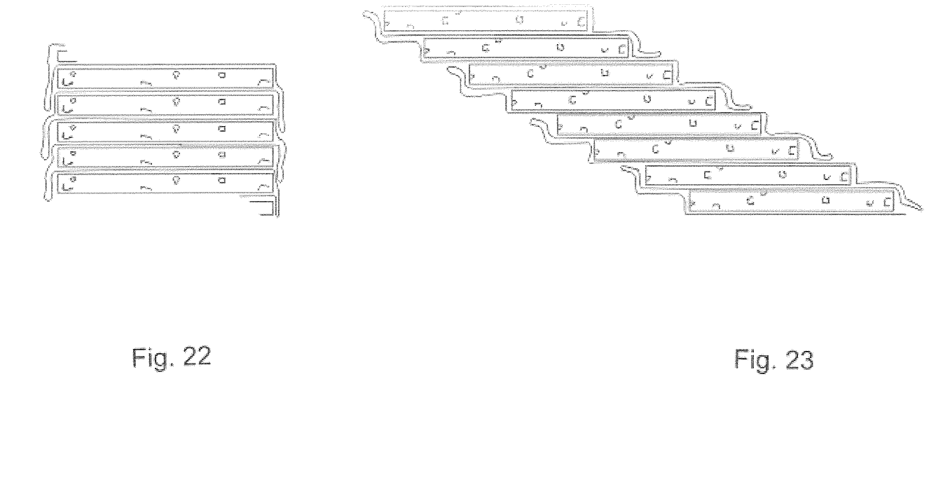

FIG. 15—Section B-B′—FIG. 12 section shows the knife position (f) as the only food block support, after it has cut a slice;

FIG. 16—Section C-C′—FIG. 13 section shows the separator grid position (GS) after its displacement to cover the placed slice on the belt (E). At the time of separator grid displacement the support grid (GA) has already been displaced to its origin position, in order to start a new cutting cycle;

FIG. 17—Slice cutting process of distinct blocks—the sequence of figures A, B and C demonstrates the slice cutting process in distinct blocks, where uneven slices (fi) are always cut in block A and even slices (fp) are always cut in block B;

FIG. 18—Delimiters (d)—are devices that move, by mechanical action below the cutting grid, on tabs fastened to the device frame. They have the function of keeping programmed length the continuous flexible separator (s), in their coming and going routes;

FIG. 19—Vertical belt driver—is a device consisting of a worm screw (r), through which a threaded bearing moves (m) which supports a belt (e), that serves as a support for a slice stack. It is driven a corona rotation (c), intermittently, which causes vertical downward movements of the threaded bearing, until completing the desired number for forming a slice stack. After the stack is removed from the slice placing plan, through the action of a horizontal belt driver, the bearing and belt return to their original positions, in a single vertical upward movement, by the vertical driver action (av). The threaded bearing upward movement is free and does not depend on the thread movement;

FIG. 20—Horizontal stacking—in horizontal stacking slices are stacked, one over the other, beyond the immediately lower slice projection;

FIG. 21—Flaps—Flaps are formed by excess measurements of the continuous flexible separator (s) in relation to slice measurements (f);

FIG. 22—Side surface protection process of slices in vertical stacking—in vertical stacking, through mechanical drive, flaps are folded on side surfaces of slices, preventing contact with the environment;

FIG. 23—Side surface protection process of slices in horizontal stacking—in horizontal stacking the flaps cover exposed surfaces of slices that do not get in contact with bottom surfaces of immediately higher slices—as well as cover side surfaces of all slices, preventing contact with the environment.

### SLICE CUTTING PROCESS

Storing parts (5) of food blocks are rounded or polygonal parts, without lid and bottom—consisting of side walls only, with measures and number of walls equal to the shape of blocks to be sliced, with functions of driving blocks and giving them passage, from top to bottom, in order to enter a fractioning process by slices.

The food block support, when passing through the storing parts, is done by a hard support fastened to the cutting grid (8), in a lower plan to the knife fastening plan, also fastened to the same grid. Alternately, the knife can be circular, rotary (8-A), whose central shaft has its cradle in the cutting grid and is mechanically driven by gears or pulleys The support positioning is adjustable and the slice thickness is determined by the measurement of the space between upper surface plans of the support and the knife cutting edge.

When the knife starts the first cutting movement, the hard support, at the same speed, (9B/C) loses the sole food block support condition. At the time when the knife finishes its cutting movement, originating a slice, it becomes the only support for the block (9D) and, next, the grid return movement starts, taking the knife and the hard support to their original positions, in order to start a new cutting movement. These movements are synchronized with the other device movements, through electrical or electronic signals.

At the end of the grid return movement, the knife fully loses contact with the food block (9A) and the latter, without the knife support, goes down by gravity action until it is contained by the hard support, which limits its descent.

The downward food block movement describes a measurement path equal to the programmed measurement for slice thickness.

The cutting grids work jointly and are alternately moved—when a slice of the so-called uneven block is cut, not cutting the event block slice and vice-versa.

Alternately, slices can be cut from a single block (10); however, to this end, at every cutting movement and a new slice placing the food block must be moved off the slice placing plan, in order to give passage to the flexible separator (13).

The cut of slices originating from a single block is done by a support grid (GA), which supports and allows the cutting gird displacement (GC), also mechanically driven, to slice the food block. In its first displacement the support grid is found off the slice placing plan, where it displaces the flexible separator driver (10). Supported by sliding tabs the grid moves in the perpendicular direction to the separator spool displacement, in order to place the support (A) in the slice cutting and placing plan (11), allowing the cutting grid movement start in the same displacement direction of the support grid (GA), in order to cut a slice (F) and place it on the continuous separator (S), stretched on the belt (E) (12).

### Slice Stacking and Separation Process

Food slices, placed for forming the same stack of slices, can be cut from a single block or cut from two distinct food blocks—a situation in which uneven number stacks will always be originating from a single block and even number slices will always be originating from another block. When cutting slices originating from alternating blocks the flexible separator driver is located between storing parts (17) of referred food blocks and moves jointly with storing parts, describing the same path in the same time. After being cut and place the first uneven slice, originating from the block called “A”, the fable starts the going path—in order to drive the separator in the function of covering the uneven slice (fi) and, at the same time, displace block “A” from its original position, as well as to place block “B” in the previously occupied position by the uneven block (17A/B). After being covered the uneven slice, a new slice—the even number one (fp), originated from block “B”, is cut and place on the continuous separator, exactly in the uneven slice projection (17B). A table coming movement then follows—in order to drive the separator to the function of covering the even slice, as well as to place food blocks again in their original positions (17C), a necessary condition for staring a new table coming and going cycle. Slice cutting is done by a mechanical drive programmed by electrical or electronic signals, in synchronism with the table movements.

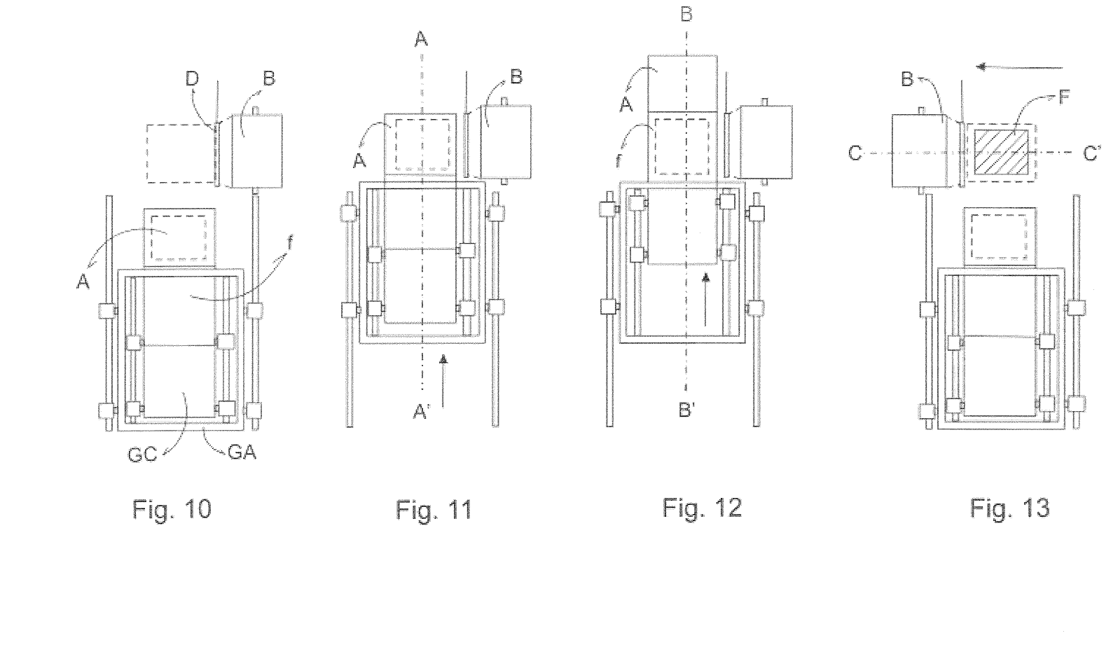

When cutting slices originating from a single block support is and cutting grid (GC) positionings are synchronized with the flexible separator grid movement (GS) so that they will not be as the same time, in the slice cutting and placing projection plan (FIGS. 10, 11, 12, 13, 14, 15 and 16).

Both in vertical stacking and horizontal stacking slice placing is done by gravity action. After the first slice is placed, it is covered by the continuous separator during the driver going path (18) and, at its end, a new slice is placed by gravity action, allowing the driver coming path start; and so successively. Slice placing is immediately done after they have been cut from the food block and slices fall exactly in the programmed place for forming the stack, without interference by any other action than gravity. Slice placing alignment is done by using a shield, (6) which acts as counter knife, which is located in the knife cutting edge projection—at the end of its cutting movement, in order to prevent cutting speed movements from displacing the slices beyond the defined projection for forming the stack.

In vertical piling food slices are placed on projections one on tope of the others, form a stack on a belt, which goes down, at every new slice placing, whose downward path is equal to the slice thickness, with the function of allowing the placing process of each slice to be done always at the same plan. The intermittent descent of the belt is done by mechanical action synchronized with the slice placing action, through the vertical belt driver—a device (19) consisting of a worm screw, through which a threaded bearing is moved that supports the belt, which is the support for the slice stack. The worm screw is driven through a corona, intermittently, causing vertical bearing downward movements, until completing the desired number for forming a slice stack. After the stack has been removed from the slice placing plan, through the action of the horizontal belt driver, the threaded bearing and belt return to their original positions, in a single vertical upward movement, by mechanical action. The bearing upward movement is free and does not depend on the thread movement. Slice placing is programmed to form a stack with the desired number of slices. After placing the last slice for forming a stack, a driver coming and going cycle occurs, without there being cutting and placing of new slice, at the same time the belt runs an equal path to twice the driver path length, for removing the slice stack from the placing stack and allowing forming a new stack. Then the belt, driven by an electrical or electronic signal, is raised, by mechanical action, to the initial plan, in order to start forming a new slice stack, and so successively.

In horizontal stacking, in the shape of scales, a slice stack is formed in which part of the upper slice is in contact with the immediately lower part of the slice (20). The upper slice placing over part of the immediately lower part of the slice occurs as a result of the slice stack being formed on a belt that moves in the horizontal plan, intermittently, at every new slice placing, causing this horizontal stacking—in the form of scales. The belt intermittent movement is done by programmed mechanical action, synchronized to slice placing movements, through the horizontal belt driver. After placing the last slice, for forming a stack, a driver coming and going cycle occurs, without there being cutting and deposition of a new slice; at the same time the belt runs an equal path to twice the driver path length, for removing the slice stack from the slice placing plan and allowing forming a new stack.

### Slice Protection Process

The stacked food slice protection process is done by a continuous flexible separator that, in coming and going paths, involves food slices—one going and the other coming, at the time of their stacking, separating them one from the other and preventing contact between their front and rear surfaces. The separator width (s) is larger than the slice width (f) and the separator coming and going path, which determines their length, is larger that the slice length, whose measurement differences form flaps—located beyond the slice side limit projections (21).

The continuous separator driver, located between the storing parts, makes its coming and going path after every food slice placing on the separator. At every driver path, coming or going, a segment of the flexible continuous separator is released from the spool, whose length is exactly equal to the path run by the driver. The flexible continuous separator release is done through the action of tractor cylinder (3), consisting of a shaft, a tractor cylinder and an opposing cylinder, fastened to the mobile frame upper surface that, when turning, jointly, exerts traction on the flexible separator, causing it to be released from the respective spool. At the end of the cylinder tractor shaft geared corona are fastened with worm wheels. Which turn in ratchet-type bearings—which allow free movements in one of the rotation directions. At the end of the shaft the worm wheel is geared in upper teeth of one of the two coronas and at the other end the worm wheel is geared in the lower teeth of the other corona, causing rotary movements of the tractor shaft in a single direction, continuously, at every worm wheel coming and going movement. This mechanism allows continuous release of the flexible laminated segments, both in coming and going of the driver. The flexible separator is passively released from the spools that turn on a shaft (2) fastened to the upper end of the mobile frame. After completing the first flexible separator going path and placing the first food slice on it, a delimiter (d) (18) is inserted into the end point of the going path with the function of keeping the separator length equal to programmed length for their paths and preventing the separator from being displaced when its coming path is started. Likewise, another delimiter is inserted into the end point of the separator coming path, with the function of preventing separator displacement when its next going path is started, and so, successively. Delimiters are inserted in a perpendicular direction to the driver paths and, at the end of each path—coming or going, they are activated to return to their initial positions and being again inserted after a new slice is placed, and so successively. Delimiter movement is synchronized with driver movements according to the action programming and their respective drivers.

In vertical stacking referred flaps are folded one on top of the other, protecting the food side surfaces (22). Flap folding is done by mechanical action, before placing the stack of slices in its outer packaging, which can be simply closed or submitted to vacuum or any other modifying process of their inner atmosphere.

In horizontal stacking, where the upper slice is placed on part of the immediately lower slice (23), the flexible separator flaps laid on the slice stacking shaft, have the necessary size to cover the frontal surface of part of the lower slice surface so that there will be no contact with the rear surface of the immediately upper slice, as well as to cover part of the upper slice that does not get in contact with the frontal part of the immediately lower slice, as well as to cover side surfaces of the slices, in the flexible separator length shaft. Flaps formed in the slice width shaft protect their side surfaces due to being folded, one on top of the other, when packed in their outer package, which can be simply closed or submitted to vacuum, or submitted to any modifying process of their inner atmosphere.

The movement of the appliance active devices is done by mechanical action, through pneumatic mechanisms or threads driven by en electric motor, or another, by direct action or by indirect action—through articulated arms or corona and worm wheels. The motors or pistons—activated by pneumatic valves, are programmed by an electrical or electronic equipment.

The appliance, covered by this patent, can consist of a single production line—a tractor shaft, a flexible separator driver, a single knife and support set, a delimiter set, a single belt, etc; or it may consist of a production line, by using common mechanical drivers to the several lines or independent mechanical drivers for each production line.

Along the report of this patent a food slice was understood to be a flat, rounded or polygonal part, horizontally laid out, whose front surface is the face of the slice turned upward, whose rear surface is the face of the slice turned downward and whose side surface is the face corresponding to its thickness.

1. Process for slicing, separating, stacking and protecting food slices, characterized by separating stacked slices by a flexible continuous separator and removing slice stack from their placing plan.

2. In accordance with claim number 1, the process for slicing food blocks, characterized by the use of mobile cutting grid, to which a knife is fastened—fixed (f) (8) or rotary (fr) (8A)—and a support is fastened (a), in different plans, whose difference of measurements between their respective plans delimits slice thickness.

3. In accordance with claim number 1, the process for vertically or horizontally stacking food slices, during the cutting process, in aligned manner, characterized by using gravity force action and a shield (acf) (6) counter knife.

4. In accordance with claim number 1, the process for separating food slices, in stacking phase, characterized by using a flexible continuous laminated separator between slices, in coming and going paths (7).

5. In accordance with claims number 1, number 3 and number 4, process for slicing, stacking and separating food slices alternately, characterized by obtaining uneven slices from one block and even slices for another block, by using a guided flexible continuous separator between each block (17).

6. In accordance with claims number 1, number 3 and number 4, alternately, a process for slicing, stacking and separating food slices, characterized by slicing a single block and removing it from the slice placing plan, at every cut, in order to give passage to the flexible continuous separator driver (16/17).

7. In accordance with claims number 1 and number 4, characterized by a process for obtaining programmed measurements for flexible continuous separator segments—folded at the end of their coming and going movements by using delimiters (18) at flexible continuous separator folding points.

8. In accordance with claims number 1, number 4 and number 6, characterized by a process for protecting side surfaces of food slices, from exposure to the environment, vertically stacked by using flaps, formed by shaft measurement excess of a flexible continuous separator segments in relation to respective slice shaft measurements, folded over slice side surfaces (21/22).

9. In accordance with claims number 1, number 4 and number 6, characterized by a process for protecting side surfaces of food slices, from exposure to the environment, horizontally stacked by using flaps, formed by shaft measurement excess of a flexible continuous separator segments in relation to respective slice shaft measurements, folded slice side surfaces and with sufficient length to protect the front of the lower slice part that does not get in contact with the immediately upper rear surface; as well as for protecting part of the upper slice of the rear surface that does not get in contact with the front surface of the immediately lower, as well as for covering slice side surfaces, in flexible separator length shaft (21/23).

10. In accordance with claim number 1, a process for removing slice stacks from their stacking plan, after having completed the programmed number of slices, characterized by the occurrence of a coming and going cycle from the driver, releasing two flexible separator segments—without cutting and placing a new slice, at the same time as the belt runs a space equal to twice the driver path length.

11. In accordance with claim number 1, an electronic programming process for memorizing, counting and synchronizing a set of mechanical actions, characterized by issuing a first signal to the cutting process of one of the food blocks and immediate return of one the knife grids to its initial position; a second signal to the insertion process of one of the separator delimitating groups, a third signal for moving the table in its going path and, at the same time, moving tractor cylinders for releasing flexible separator segments; a fourth signal for lowering the vertical stack support of slices and, in the case of horizontal stacking, the same fourth signal for concomitant horizontal belt displacement; a fifth signal for the other food block cutting and immediate return of the other knife grid to its initial position; a sixth signal for the insertion process of the other separator delimitating group; a seventh signal for moving the table in its coming path—returning it to its initial position and, simultaneously moving tractor cylinders for releasing continuous flexible separator segments; repetition of signals—from the first to the seventh, according to programming for the number of slices per stack; an eighth signal for the table to be moved in the going path, with respective separator segment release and with signal suppression for cutting a new slice; a ninth signal to the belt to remove the stack of slices from their cutting plan and a tenth signal for moving the support base return of the stack of slices to its initial position, from which a new signal cycle will be started for forming a new stack of slices.

12. Appliance for slicing food blocks, stacking and protecting slices, consisting of a fixed frame on which a mobile frame slides, where one or more device groups operate, characterized by intermittently unwinding spools, flexible continuous laminated segments, with programmed measurements and in synchronism with food block movements; slicing food blocks; stacking and aligning obtained slices; separating slices through the flexible continuous separator drivers and delimitating separator measurements at the time of slice separation; vertically, intermittently moving, from top to bottom, the slice stack support base; removing the slice stack from the placing plan of new stacks and vertically moving, from top to bottom, the slice stack support base.

13. In accordance with claim number 12, an appliance for unwinding spools, continuously, flexible continuous laminated segments, with programmed length measurements, both in going, and coming of the mobile frame, characterized by using a cylinder-tractor (3), mechanically driven, coupled with ratchet-type bearings, at their ends, where mobile coronas rotate geared on fixed worm wheels, inverted, or through mechanical action directly applied on cylinder-tractor, synchronized with every mobile table coming and going movement.

14. In accordance with claim number 12, an appliance for guiding, in coming and going paths, flexible continuous separator of food block slices, alternately cut, characterized for being a mobile table (4), on which a driver is located—through which the flexible separator passes, (4A) between two storing parts—through which food blocks to be sliced pass.

15. In accordance with claim number 12, an appliance for supporting and slicing food blocks with programmed slice thickness 5 measurement, characterized for being a sliding cutting grid (8), on which supports and knives are fastened in different plants,. whose plan difference delimitates slice thickness.

16. In accordance with claim number 12, an appliance for aligning slice placing for forming stacks, preventing slices from being displaced by the knife—due to its speed, beyond desired positioning, characterized for being a counter knife shield, (6) located in the end plan of the knife cutting edge movement.

17. In accordance with claim number 12 and number 14, an appliance for delimitating flexible continuous separator segments in an equal measurement to the measurements of coming and going paths of separator driver, characterized for being a set of delimiters, (18) mechanically driven, at the programmed point for separator folding—at the end of drivers' coming and going movements.

18. In accordance with claim number 12, an appliance for moving from top to bottom, intermittently, the support base slice stacks at every placing of a new slice and in an equal path to slice thickness measurement, characterized for consisting of a worm screw, (19) mechanically driven in rotary movements, whose movements guide a threaded bearing in downward programmed paths.

19. In accordance with claim number 12, an appliance for moving from top to bottom, a threaded bearing that supports the support base for forming slice stacks, characterized for being a bearing, whose internal thread, due to its mobility, makes a free upward movement, independent of the worm screw movement.

20. In accordance with claim number 12, an appliance for slicing, stacking and protecting slices from a single food blocks, characterized for consisting of a flexible separator spool grid (B), by a support grid (GA), on which a cutting grid slides (GC), which move in a single direction to place and remove the food block in the flexible separator grid movement projection (10/11/12/13).
